(19) United States
(12) Patent Application Publication
(10) Pub. No.: US 2007/0056133 A1
(43) Pub. Date: Mar. 15, 2007

(54) Surface finishing tool

(75) Inventors: Georgia Pyatt, Fayetteville, AR (US); Israel Holby, Fayetteville, AR (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: Marshalltown Company, Marshalltown, IA (US)

(21) Appl. No.: 11/225,469

(22) Filed: Sep. 13, 2005

(51) Int. Cl. B05C 17/10

(52) U.S. Cl. 15/235.4; 15/245.1

(57) ABSTRACT

A tool for spreading material such as drywall compound generally comprises a plate, a handle, and a frame. The plate includes a first edge and second edge that are substantially parallel to one another. A frame is coupled to the first edge of the plate, and a handle is coupled to the frame, thereby attaching the handle to the plate, the second edge of which is used for spreading material. The handle extends away from the frame and plate, and bends to extend toward and substantially transverse to the second edge of the plate, thereby increasing both the effectiveness of the tool and the comfort of the user during use of the tool.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to a tool, and, more particularly, to a tool used to spread drywall compound or other material.

### BACKGROUND OF INVENTION

There currently are two types of tools used for finishing drywall: the taping knife and the drywall trowel. A taping knife typically is used to spread drywall compound in a way that fills the joint between two pieces of plasterboard and spreads the compound approximately three inches on each side of the joint. While the drywall compound is still wet, the taping knife is used to press perforated paper over the joint until the paper stays in place. While using firm pressure, the blade of the taping knife is held at an approximately forty-five degree angle to the surface so that the paper is firmly embedded and excess drywall compound is forced out at the edges of the paper. Once the joint is dry, the taping knife or drywall trowel is used to spread an additional layer of drywall compound to dress the joint. Finally, using a drywall trowel, a thin finishing coat is built up over the joint and feathered to a distance of about four or five inches on both sides of the joint.

The current state of the art in drywall compound spreading tools presents a number of limitations. First, the operation of current drywall tools places a large amount of stress on a user's wrist. Prior art taping knifes and drywall trowels are illustrated in FIGS. 1 and 2. As seen in FIGS. 1 and 2, a blade 1 is placed into contact with a wall 2 to spread drywall compound or to press perforated paper over the joints in the wall 2. A user 3 typically applies force through the blade 1 and handle 4 in directions 5 and/or 7, and the wall 2 provides a resistance force away from the wall 2 in a direction 6. As a result of the forces applied by the user and the wall, a resultant moment 8 is formed, for which the user 3 must physically compensate with his or her wrist or arm.

Second, the grip techniques used for controlling the forces on the blade negatively affect the user. It is common for a drywall finisher to use a pinch-type grip in which the user's opposing fingers grip in a pinching fashion to hold and control the drywall tool as illustrated in FIG. 1. This type of grip requires the user to exert a significant amount of force to hold onto handle 4. Further, when the drywall tool is used at a significant distance away from the user's body, excessive wrist flexure may be needed to control the blade edge and apply the necessary pressure to spread drywall compound or press perforated paper against the wall 2.

Moreover, it is common for a user to extend his or her index and middle finger on the blade to control the forces and leave the weaker fingers to grasp the tool. When compared to the pinch-type grip, this technique requires more effort to finish smoothing a joint and reduces the amount of control the user has on the spreading edge. It is common for a user to rotate the tool about the handle centerline, pressing an end of the blade into the wall to apply the drywall compound. This technique is also detrimental to a user's wrist since additional torque must be applied to the handle for adequate control. It has been shown that a repetitive combination of the aforementioned grips and wrist flexure, while employing high-grip forces, can lead to carpal tunnel syndrome.

Third, the current handle designs are uncomfortable for a user. Specifically, when a user grips the handle of a drywall finishing tool, the design of the handle causes pressure points and discomfort on the inside of the user's hand. Additionally, as seen in FIG. 1, the end of the handle 4 interferes with the user's wrist when his or her wrist is bent or flexed since the handle is typically longer than the user's hand.

Finally, the current drywall tools provide an ineffective finishing stroke length. Typically, a user begins a drywall joint finishing stroke by extending his or her arm to position the drywall tool away from his or her body, and brings the drywall tool toward his or her body when finishing the stroke. Once the user finishes the stroke, the drywall tool must be lifted away from the plasterboard and drywall compound, set at the opposite end of the joint, and brought toward his or her body again. The user must use two strokes to complete a joint and, in the process, experiences severe wrist flexure when the tool is brought toward the body.

Thus, while drywall spreading tools are well known and commonly used, there remains a need in the construction industry for a drywall tool that reduces the amount of stress on a user's wrist. Additionally, there is a need for a drywall tool that allows a user to more easily control the forces placed on the drywall tool. Further, there is a need for a drywall tool handle design that eliminates pressure points on the user's hands and reduces interference with the user's wrist. Still further, there is a need for a drywall tool that allows a user to utilize an effective finishing stroke length and reduces wrist flexure.

### SUMMARY OF THE INVENTION

The present invention provides a tool that reduces the amount of stress on a user's wrist and allows a user to more easily control the forces placed on the drywall tool. Further, the present invention provides a tool handle design that eliminates pressure points on the user's hands and reduces interference with the user's wrist. Still further, the present invention provides a tool handle design that utilizes an effective finishing stroke length.

According to the present invention, the foregoing and other objects are achieved by a tool generally including a plate, a handle, and a frame. The plate includes a first edge and a second edge that are substantially parallel to one another. A frame is coupled to the first edge of the plate, and a handle is coupled to the frame. The second edge of the plate is generally used for spreading drywall compound. The handle extends away from the frame and plate and bends to extend toward and substantially transverse to the second edge of the plate.

Additional objects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means and instrumentalities and combinations particularly pointed out in the appended claims.

### BRIEF DESCRIPTION OF THE DRAWINGS

In the accompanying drawings which form a part of this specification and are to be read in conjunction therewith and in which like reference numerals are used to indicate like parts in the various views:

FIG. 1 is a side view of a prior art taping knife being operated by a user against a spreading surface;

FIG. 2 is a side view of a prior art drywall trowel being operated by a user against a spreading surface;

FIG. 3 is a perspective view of a tool according to the present invention;

FIG. 4 is an upper plan view of the tool shown in FIG. 3;

FIG. 5 is a lower plan view of the tool shown in FIG. 3;

FIG. 6 is a front elevational view of the tool shown in FIG. 3;

FIG. 7 is a rear elevational view of the tool shown in FIG. 3;

FIG. 8 is a side elevational view of the tool shown in FIG. 3;

FIG. 9 is a side elevational view of the tool shown in FIG. 3 being operated by a user against a spreading surface;

FIG. 10 is a side, elevational, cross-sectional view of an additional embodiment of the tool;

FIG. 11 is a perspective view of an adjustment mechanism and flange of the additional embodiment of FIG. 10;

FIG. 12 is a side, elevational, cross-sectional view of the additional embodiment of FIG. 10 where the angle between the handle and flange has been changed;

FIG. 13 is a front, elevational, cross-sectional view of the additional embodiment of FIG. 10 taken along the line 13-13;

FIG. 14 is a side, elevational view of another additional embodiment; and

FIG. 15 is a front, elevational, cross-sectional view of the additional embodiment of FIG. 14 taken along the line 15-15.

### DETAILED DESCRIPTION OF THE PREFERRED EMBODIMENT

Referring to the drawings in greater detail, and initially to FIG. 3, a tool according to the present invention is generally designated in the drawings by reference numeral 10. The tool 10 is used to spread drywall compound in the joint formed between two sheets of plasterboard, over imperfections in the plasterboard, and over joint paper or joint tape. Although the tool 10 is described as being used to spread drywall compound, it should be understood that the tool 10 can be used to spread plaster, stucco, cement, grout, mortar, caulk, elastomeric material, adhesive material, and any other soft, malleable material. Further, tool 10 can be used to spread such material on a wall, floor, ceiling, or other location made of plasterboard, drywall, cement, asphalt, wood, metal, or any other material. The tool 10 generally includes a handle 12, a frame 14, and a plate 16. The handle 12 is coupled to the frame 14, which in turn is coupled to the plate 16. As seen in FIGS. 3 and 6-8, the handle 12 includes a grip 18, a support 20, and a base 22. As described below, the grip 18 and the support 20 are adapted such that handle 12 is positioned over plate 16.

The grip 18 of the handle 12 is held by a user in order to operate the tool 10. With reference to FIGS. 4 and 6-8, the grip 18 and the support 20 of the handle 12 are shaped and contoured in such a way to minimize or eliminate pressure points that occur when a user grasps and operates the tool 10. In one embodiment, the grip 18 and the support 20 of the handle 12 are integrated in a single unit. Alternatively, the grip 18 and the support 20 may be separate units in which the grip 18 is press-fit, molded onto, or otherwise attached to the support 20. However, is should be understood by one of ordinary skill in the art that the grip 18 and support 20 may be connected by other means such as rivets, bolts, clasps, screws, adhesive, glue, welding, or the like. Further, the handle 12 can be made of wood, metal, rubber, polymeric material, or any other suitable material that will enable a user to grip the handle 12 and operate the tool 10.

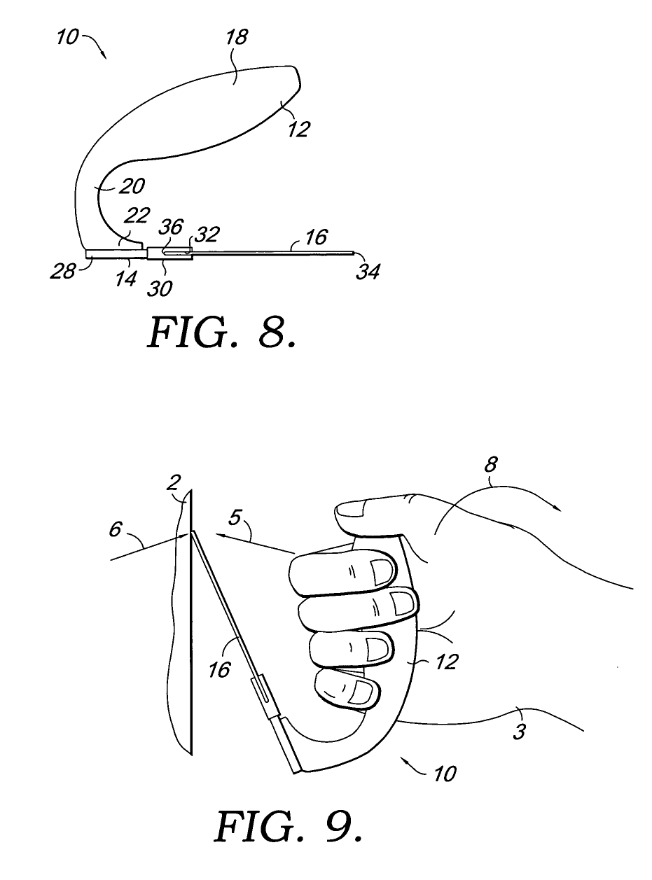

With reference to FIGS. 4 and 6-8, the support 20 and base 22 will be discussed. The base 22 is adapted to rigidly mount the support 20 to the frame 14. With reference to FIG. 8, the support 20 extends generally vertically from the frame 14 and base 22 and curves rearward such that a longitudinal axis of grip 18 is positioned at an angle with respect to the plane of plate 16.

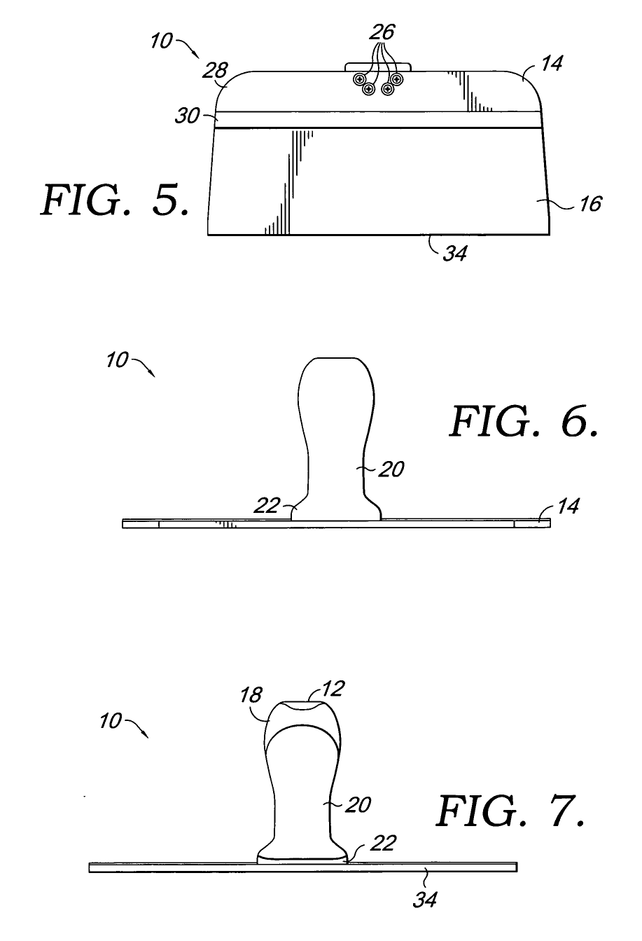

Referring now to FIGS. 5-8, the base 22 will be discussed. The base 22 includes apertures or holes, not shown, that are adapted to receive screws 26 to couple the support 20 to the frame 14. It should be understood that the frame 14 and the support 20 may be formed as an integral member, thereby eliminating the need for fastening the two parts by screws, nuts, bolts, welds, rivets, adhesive, or the like. Further, the support 20 may be formed of metal, wood, plastic, polymeric material, or any other material that will provide a rigid connection between the handle 12 and the frame 14.

The frame 14 is generally used to connect the handle 12 to the plate 16. With reference to FIGS. 4 and 5, the frame 14 is generally rectangular with two rounded corners. Referring now to FIG. 8, the frame 14 includes a mounting portion 28 and a channel portion 30. The mounting portion 28 and a channel portion 30 may be integrally formed, or may be separate pieces coupled together. Referring now to FIG. 5, the mounting portion 28 contains apertures or holes, not shown, that are adapted to correspond to the apertures or holes, not shown, located in the base 22 of the handle 12. The screws 26 are inserted into and through corresponding apertures or holes in the base 22 and mounting portion 28 to interconnect the handle 12 to the frame 14. It will be understood that handle 12 and frame 14 may be connected by rivets, bolts, welding, adhesive, or other means well known to those of skill in the art. The frame 14 may be made of metal, wood, plastic, polymeric material, or any other material that will provide a rigid connection between the handle 12 and the plate 16.

Referring again to FIG. 8, the channel portion 30 of the frame 14 extends away from the mating portion 28. In one embodiment, the channel portion 30 extends in a horizontal direction and lies along the same plane as the mating portion 28. Alternatively, the channel portion 30 may be bent relative to the mating portion 28 to adjust the angle between the grip 18 and the plate 16. Thus, the angle at which grip 18 is positioned with respect to the plane of the plate 16 can be fixed by bending the frame 14 or the plate 16. The channel portion 30 also includes a channel 32, as seen in FIG. 8. The channel 32 extends along the longitudinal edge of the frame 14 and is adapted to receive an attachment edge 36 of plate 16. It should be understood that the base 22, support 20, and frame 14 are not the exclusive fastening means for attaching the handle 12 to the plate 16. It is within the scope of this invention to employ fastening means having one or more members connecting the handle 12 to the plate 16, provided the handle 12 is positioned over the plate 16 and the handle 12 is coupled to the plate 16.

With reference to FIGS. 4-8, plate 16 generally is substantially planar and rectangular shaped. As stated above, it should be understood that plate 16 could be bent or curved to vary the angle at which handle 12 is positioned with respect to the plane of plate 16. Further, plate 16 includes a spreading edge 34 and an attachment edge 36. As best seen in FIGS. 4 and 8, the attachment edge 36 is received in the channel 32 and the plate 16 is coupled with the channel portion 30 by punches 38. It should be understood that the plate 16 may be fixably coupled to frame 14 by other means such as rivets, bolts, clamps, screws, adhesive, glue, welding, or the like. The spreading edge 34 is the portion of plate 16 that makes contact with the wall and is used for spreading drywall compound or pressing joint paper or tape in the joints of the wall. As seen in FIG. 4, the handle 12 is preferably positioned over the plate 16 and extends toward and transversely to the spreading edge 34. It should be understood that the plate 16 may be made out of metal, plastic, polymeric material, or any other material suitable for spreading drywall compound.

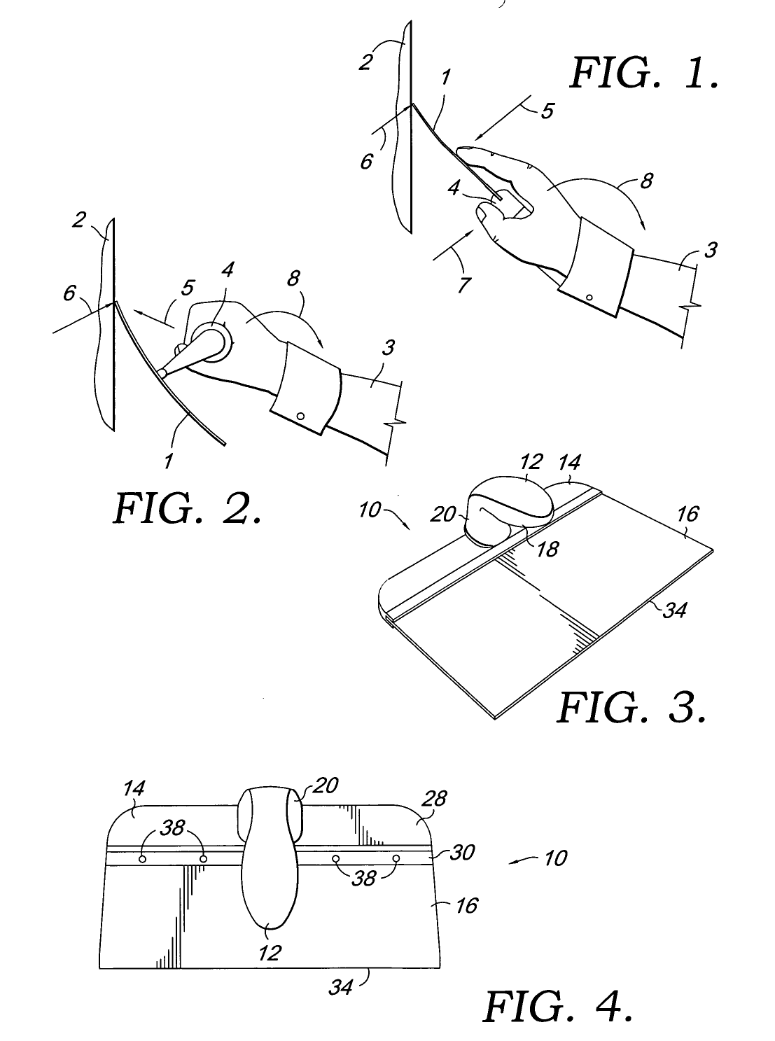

In operation and as best seen in FIG. 9, a user 3 grasps the tool 10 by handle 12. User 3 then begins to apply drywall compound with the plate 16 of tool 10. While the user is applying the drywall compound, the line of force imparted to tool 10 extends, in direction 5, substantially parallel to the axis of the user's wrist and through the point at which plate 16 makes contact with wall 2. As with the prior art tools shown in FIGS. 1 and 2, wall 2 provides a resistive force in direction 6 away from wall 2. However, because the present invention allows a user 3 to impart a force through the point of contact between plate 16 and wall 2, the amount of resultant moment 8 that must be resisted by the user 3 is substantially reduced. Further, the grip implemented by user 3 and depicted in FIG. 9 substantially reduces or eliminates the possibility that handle 12 will interfere with the user's wrist.

It should be understood that the angle between the longitudinal axis of the grip 18 and the plane of the plate 16 can be varied by, for example, pivotally coupling the base 22 to the frame 14 such that the pivotal connection between the base 22 and the frame 14 allows a user to selectively position the handle 12 and grip 18 to a desired angle with respect to the plane of plate 16. In addition, the angle between the longitudinal axis of the grip 18 and the plane of the plate 16 can be varied by pivotally coupling the base 22 to the support 20 or by pivotally coupling the support 20 to the grip 18.

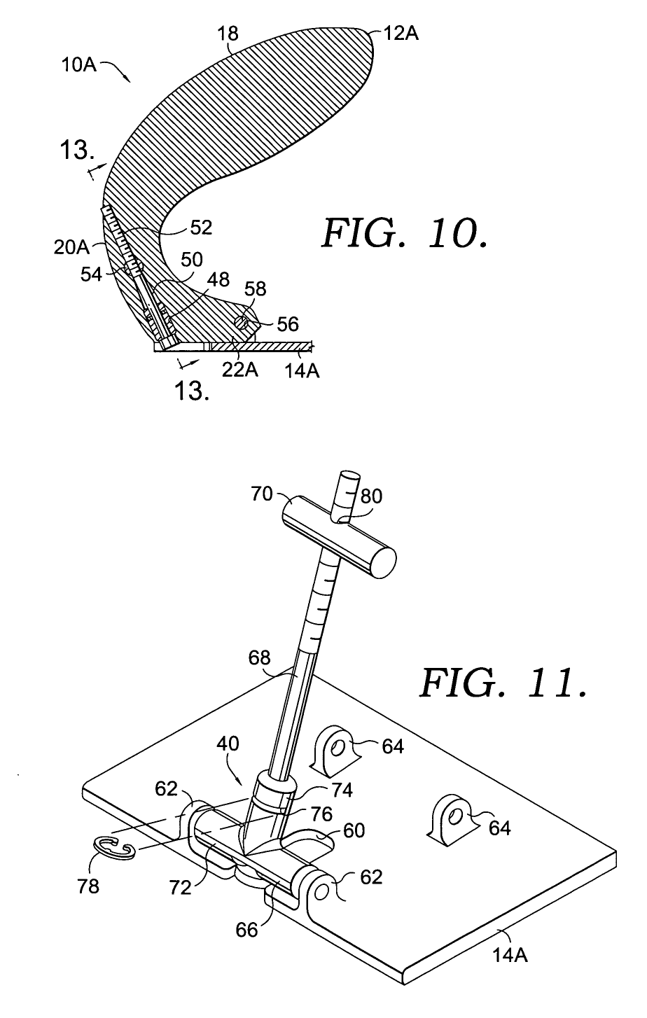

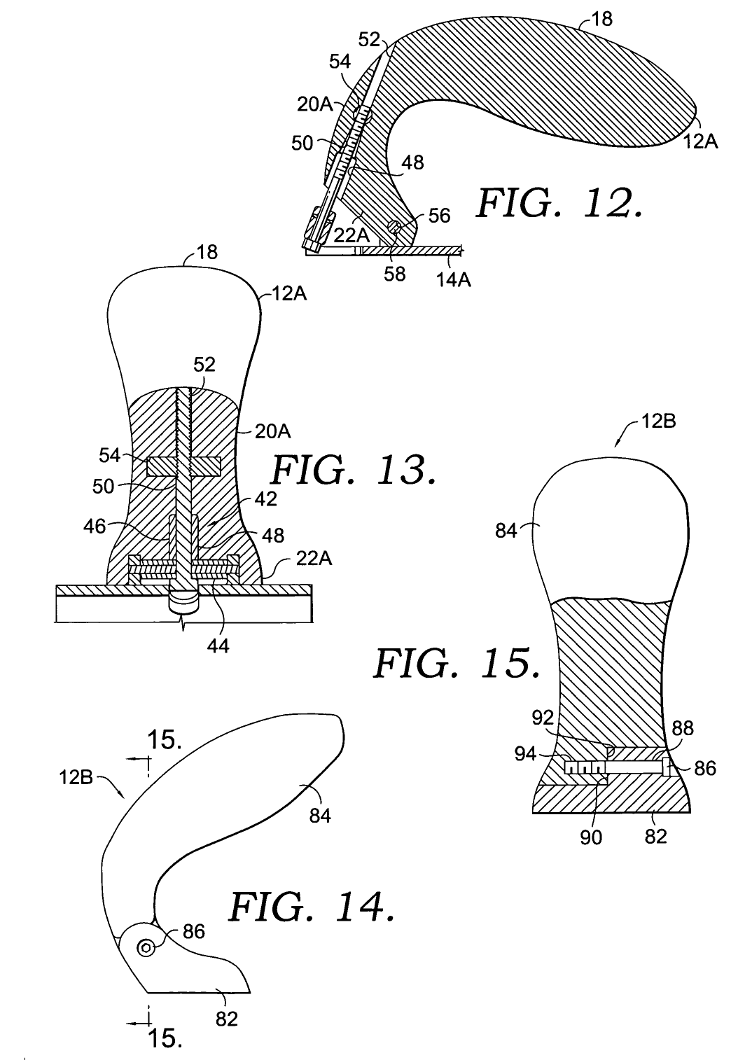

Referring now to FIGS. 10-13, an additional embodiment of the tool 10A will be discussed. The tool 10A contains a handle 12A, a frame 14A, and an adjustment mechanism 40. The handle 12A is pivotally attached to the frame 14A. As best seen in FIGS. 10, 12, and 13, the handle 12A includes the grip 18, a support 20A, and a base 22A. The remainder of the elements of the tool 10A are the same as the previous embodiment, discussed above. As best seen in FIG. 13, the support 20A and the base 22A have a cavity 42 formed therein for receipt of the adjustment mechanism 40, see FIG. 11, as will be discussed further below. The cavity 42 contains a channel 44 and a bore 46. The channel 44 extends transversely across the base 22A. Referring specifically to FIGS. 12 and 13, the bore 46 is formed within the support 20A and extends upwardly from the channel 44. The bore 46 has a lower section 48, a middle section 50, and an upper section 52, the importance of which will be discussed further below. The upper section 52 has a cylindrical space 54 formed therein. The base further contains a cylindrical opening 56. The opening 56 is located at a rearward portion of the base and receives a pin 58 to couple the handle to the frame 14A.

Referring now to FIG. 11, the frame 14A contains a recess 60 and a front and rear set of flanges 62, 64. The flanges 62, 64 extend upwardly from the frame 14A. With the exception of the recess 60 and the flanges 62, 64, the frame 14A is the same as discussed above. The flanges 62, 64 are used to attach the handle 12A to the frame 14A via the adjustment mechanism 40.

Referring again to FIG. 11, the adjustment mechanism 40 includes a T-shaped member 66, a bolt 68, and an insert 70. The T-shaped member includes a mount 72 and a collar 74. As best seen in FIGS. 10, 11, and 13, the mount 72 is cylindrical and received within the channel 44 in the cavity 42. The mount 72 is rotatably coupled to the front set of flanges 62. The pin 58 received in the opening 56 is rotatably coupled to the rear set of flanges 64. It should be understood that any suitable attachment method may be used.

The collar 74 extends upwardly from the mount 72 and is received within the bore 46. Specifically the collar 74 is received within the lower section 48 of the bore 46. The collar 74 contains a slot 76 at an intermediate position that receives a clip 78. The clip 78 serves to limit the axial movement of the bolt 68 while still allowing rotational movement. The bolt 68 extends within the upper portion 52 of bore 46.

The adjustment mechanism 40 further includes the insert 70 located at an intermediate position within the support 46A. The insert 70 is a cylindrical collar that is fixably coupled within cylindrical space 54 in the support 46A. The insert contains a threaded aperture 80 that is aligned with the bore 46 and receives the bolt 68.

As stated above, the additional embodiment of the tool 10A contains a handle 12A that is pivotally attached to the frame 14A. The angle of orientation of the handle 12A may be changed with respect to the frame 14A by the user simply rotating the bolt 68. Rotation of the bolt 68 causes the handle 12A to move with respect to the frame 14A as shown when viewing FIGS. 10 and 12. Specifically, rotation of the bolt 68 causes the bolt 68 to move within the bore 46 due to the threaded engagement of the bolt 68 with the insert 70 in the cylindrical space 54 within the support. More specifically a counterclockwise rotation of the bolt 68 would raise the handle 12A while a clockwise rotation would lower the handle 12A.

Referring now to FIGS. 14 and 15, yet another additional embodiment of the handle 12B will be discussed. The remainder of the components are the same as discussed above. The handle 12B is a two-piece member including a base 82 and a grip 84. The base 82 is adapted to rigidly mount the handle 12B to the frame 14 as discussed above with respect to the first embodiment. The grip 84 is rotatably coupled to the base 82 by a bolt 86. As best seen in FIG. 15, the base 82 includes a cylindrical hole 88 and a mating surface 90. The grip 84 also includes a mating surface 92 and a threaded hole 94. The mating surface 90 of the base 82 and the mating surface 92 of the grip 84 align and abut. The bolt 86 is threaded through the cylindrical hole 88 and into the threaded hole 94. As such, when the bolt 86 is tightened, the mating surfaces abut and the grip 84 cannot move relative to the base 82. However, a simple loosening and tightening of the bolt 86 allows the mating surface to disengage and engage thereby allowing the orientation of the grip 84 to be changed relative to the base 82.

Constructed and operated as previously described, the invention has numerous advantages that remedy the deficiencies of the prior art. Specifically, the present invention provides a tool that is configured to reduce the amount of torque on the user's wrist, making it easier and more comfortable for the user to perform the task of applying drywall compound to plasterboard. Additionally, the handle configuration of the present invention makes it is easier to control the forces to the ends of the blade or plate when the user is feathering the compound away from the sides of a joint to make the plasterboard appear flat and smooth. The configuration provides the ability to easily apply lateral torsion to the handle to allow the tool to be controlled and twisted from side to side. Further, the handle of the present invention is contoured in such a way as to reduce the gripping power required to control the tool and to reduce or eliminate pressure points on the hand of a user. Still further, the present invention is designed such that the length of the tool's handle is not critical and ensures that the handle does not interfere with the user's wrist during operation of the tool.

From the foregoing, it will be seen that this invention is one well-adapted to attain the ends and objects herein above set forth together with other advantages which are obvious and which are inherent to the structure. It will be understood that certain features and subcombinations are of utility and may be employed without reference to other features and subcombinations. This is contemplated by and is within the scope of the claims. Since many possible embodiments may be made of this invention without departing from the scope thereof, it is to be understood that all matter herein set forth or shown in the accompanying drawings is to be interpreted as illustrative and not in a limiting sense.

What is claimed is:

1. A tool for spreading a material, comprising:
a plate, said plate having a first edge and a second edge, said second edge adapted to spread a material; and
a handle attached to said plate, said handle extending from said plate at an angle and toward said second edge, wherein said handle has a longitudinal axis that is substantially transverse to said second edge.

2. The tool of claim 1, further comprising a flange, said flange coupled with said handle and said first edge of said plate.

3. The tool of claim 2, wherein said first edge and said second edge are substantially parallel.

4. The tool of claim 3, wherein an angle between said handle and said plate is adjustable.

5. The tool of claim 4, wherein said handle is pivotally coupled to said plate.

6. The tool of claim 5, wherein said handle comprises a cavity and an adjustment mechanism received in said cavity, wherein said adjustment mechanism varies said angle between said handle and said plate.

7. The tool of claim 6, wherein said adjustment mechanism comprises a bolt, a member, and a threaded insert.

8. The tool of claim 5, wherein said handle comprises a grip and a base portion, wherein said grip is pivotally coupled to said base.

9. The tool of claim 8, wherein said base comprises an aperture and a mating surface.

10. The tool of claim 9, wherein said grip comprises a threaded portion and a mating surface, wherein said mating surfaces of said grip and said base abut, and wherein said threaded portion and said aperture of said grip and said base align to receive a bolt.

11. A tool for spreading a material, comprising:
a substantially planar plate, said plate having first and second edges, said second edge adapted for spreading material;
a handle having a longitudinal axis; and
a flange coupled between said handle and said first edge of said plate, whereby said handle is coupled with said plate, said handle extending from said flange at an angle and toward said second edge of said plate.

12. The tool of claim 11, wherein the longitudinal axis of said handle is substantially transverse to said second edge.

13. The tool of claim 12, wherein said handle is pivotally coupled with said flange.

14. The tool of claim 13, wherein said angle between said handle and said flange is adjustable.

15. The tool of claim 14, wherein said handle is pivotally coupled to said flange.

16. The tool of claim 15, wherein said handle comprises a cavity and an adjustment mechanism received in said cavity, wherein said adjustment mechanism varies said angle between said handle and said plate.

17. The tool of claim 16, wherein said adjustment mechanism comprises a bolt, a member, and a threaded insert.

18. The tool of claim 17, wherein said first and second edges are substantially parallel.

19. The tool of claim 15, wherein said handle comprises a grip and a base portion, wherein said grip is pivotally coupled to said base.

20. The tool of claim 19, wherein said base comprises an aperture and a mating surface.

21. The tool of claim 20, wherein said grip comprises a threaded portion and a mating surface, wherein said mating surfaces of said grip and said base abut, and wherein said threaded portion and said aperture of said grip and said base align to receive a bolt.
